(19) United States
(12) Patent Application Publication
(10) Pub. No.: US 2021/0097442 A1
(43) Pub. Date: Apr. 1, 2021

(54) SYSTEM AND METHOD FOR TRIGGERING A TRAINING EVENT

(71) Applicant: ATS AUTOMATION TOOLING SYSTEMS INC., Cambridge (CA)

(72) Inventors: Louis Ian CAMERON, Cambridge (CA); Daniel Blair DE VERTEUIL, Cambridge (CA)

(21) Appl. No.: 17/120,343

(22) Filed: Dec. 14, 2020

Related U.S. Application Data
(63) Continuation of application No. PCT/CA2019/050738, filed on May 30, 2020.
(60) Provisional application No. 62/684,234, filed on Jun. 13, 2018.

(51) Int. Cl. G06N 20/00

(52) U.S. Cl. CPC G06N 20/00

(57) ABSTRACT

A method for triggering a training event in a manufacturing line having at least one automation element, the method including: receiving automation data associated with the at least one automation element; detecting a trigger event based on the automation data; determining a training component associated with the trigger event; and providing access to the training component to an end user. A system for triggering a training event in a manufacturing line having at least one automation element, the system including: a data acquisition module configured to receive automation data associated with the at least one automation element; a data collection device trigger configured to detect a trigger event based on the automation data; a training module configured to determine a training component associated with the trigger event; and a notification module configured to provide access to the training component to an end user.

### RELATED APPLICATION

The present disclosure is a continuation application of PCT Application No. PCT/CA2019/050738, filed May 30, 2019, which claims priority to U.S. Provisional Application No. 62/684,234 filed Jun. 13, 2018, which are hereby incorporated herein by reference.

### FIELD

The present disclosure relates generally to a system and method for automatic training. More particularly, the present disclosure relates to a system and method for providing training in association with a manufacturing or automation environment based on a trigger event.

### BACKGROUND

Modern manufacturing and automation systems and processes are becoming more complex because these systems and processes are required to be fast, accurate and repeatable in order to provide appropriate product quality in short time frames. These systems and processes also seek to provide high machine efficiency with low downtime for maintenance, trouble-shooting and the like. For existing manufacturing and automation systems and processes, there is also a trend to provide on-going improvement in one or more of these factors in order to keep pace with the changing manufacturing environment.

Some manufacturing and automation systems have sophisticated technologies for identifying stoppages/slowdowns in equipment being used and, in some cases, will have the capability to stop the manufacturing or automation system until the issue/problem/fault can be identified. However, it can still be difficult to determine the cause or source of the machine stoppage or slow down and provide appropriate instruction in order to remedy the issue/problem. This difficulty is, at least in part, due to the complexity and speed of the manufacturing and automation systems.

While some systems and methods for diagnosing automation systems are known, they tend to be limited and may not provide appropriate insight, instruction or training with respect to the machine or fault in question.

As such, there is a need for improved systems and methods for automatically triggering training events in manufacturing and automation systems.

### SUMMARY

According to one aspect herein, there is provided a method for triggering a training event in a manufacturing line having at least one automation element, the method including: receiving automation data associated with the at least one automation element; detecting a trigger event based on the automation data; determining a training component associated with the trigger event; and providing access to the training component to an end user.

In some cases, the method may further include determining feed-back associated with the training component.

In some cases, determining feed-back may include: receiving feed-back associated with the training component from an end user; determining efficiency data associated with the training component; and correlating the efficiency data and the user feed-back to determine a feed-back score.

In some cases, efficiency data may include at least one of: the length of time the manufacturing line experienced stoppage, the length of time the end user took to address the trigger event, the amount of the training component reviewed by the end user, scores from tests initiated during the training component, and frequency of the trigger event.

In some cases, determining the training component associated with the trigger event may include: reviewing the feed-back score associated with the training component; and if the feed-back score is below a predetermined reject threshold, disregarding the training component; and retrieving a further training component associated with the trigger event; otherwise, providing access to the training component to the end user.

In some cases, the trigger event may be detected via monitoring collected operation data of the manufacturing line.

In some cases, the trigger event may be an event associated with at least one of machine stoppages, faulty part detection, out of specification operations, a machine not responding within a set time period, a new operator, new equipment, general repair and maintenance, or a combination of events.

In some cases, the trigger event is determined via machine learning.

In some cases, the training component is determined via machine learning.

In another aspect detailed herein, there is provided a system for triggering a training event in a manufacturing line having at least one automation element, the system including: a data acquisition module configured to receive automation data associated with the at least one automation element; a data collection device trigger configured to detect a trigger event based on the automation data; a training module configured to determine a training component associated with the trigger event; and a notification module configured to provide access to the training component to an end user.

In some cases, the notification module may be further configured to determine feed-back associated with the training component.

In some cases, determining feed-back via the notification module may include: receiving feed-back associated with the training component from an end user; determining efficiency data associated with the training component; and correlating the efficiency data and the user feed-back to determine a feed-back score.

In some cases, the efficiency data may include at least one of: length of time the manufacturing line experienced stoppage, the length of time the end user took to address the trigger event, the amount of the training component reviewed by the end user, scores from tests initiated during the training component, and frequency of the trigger event.

In some cases, the training module may be further configured to: review the feed-back score associated with the training component; and if the feed-back score is below a predetermined reject threshold, disregard the training component; and retrieve a further training component associated with the trigger event; otherwise, provide access to the training component to the end user.

In some cases, the trigger event may be detected via monitoring collected operation data of the manufacturing line.

In some cases, the trigger event is an event associated with at least one of machine stoppages, faulty part detection, out of specification operations, a machine not responding within a set time period, a new operator, new equipment, general repair and maintenance, or a combination of events.

Other aspects and features of the embodiments of the system and method will become apparent to those ordinarily skilled in the art upon review of the following description of specific embodiments in conjunction with the accompanying figures.

### BRIEF DESCRIPTION OF FIGURES

Embodiments of the system and method will now be described, by way of example only, with reference to the attached Figures, wherein:

FIG. 1 is a block diagram illustrating an embodiment of a system for triggering a training event and an example environment for the system;

FIG. 2 is a block diagram illustrating another embodiment of a system for triggering training events;

FIG. 3 is a flowchart of an embodiment of a method for triggering training events for an automation systems;

FIG. 4 illustrates an end user interaction with the system for triggering a training event according to an embodiment;

FIG. 5 is a flowchart of an embodiment of a method of triggering and selecting a training event; and

FIG. 6 is a flowchart of an embodiment of a method for providing feedback in relation to a triggered triggering training event.

### DETAILED DESCRIPTION

The following description, with reference to the accompanying drawings, is provided to assist in understanding the example embodiments. The following description includes various specific details to assist in that understanding but these are to be regarded as merely examples. Accordingly, those of ordinary skill in the art will recognize that the various embodiments and changes and modifications thereto described herein can be modified without departing from the scope and spirit of the appended claims and their equivalents. In addition, descriptions of well-known functions and constructions may be omitted for clarity and conciseness.

The terms and words used in the following description and claims are not limited to their bibliographical meanings, but, are meant to be interpreted in context and used to enable a clear and consistent understanding.

Generally, the present document provides for embodiments of a system and method for triggering a training event in association with automation systems. In one embodiment, the system and method may include a trigger-driven data gathering approach. In another embodiment, the system and method may include providing data and training to third parties that may be involved with the training or may be involved in diagnosing and fixing an issue, fault or problem associated with the automation and/or manufacturing system.

Automation stations are used on manufacturing or production lines to handle manufacturing operations. An automation station may include a single machine in a production line, such as a press or the like, but may also include a complex system involving robots, conveyors, manipulators, and the like.

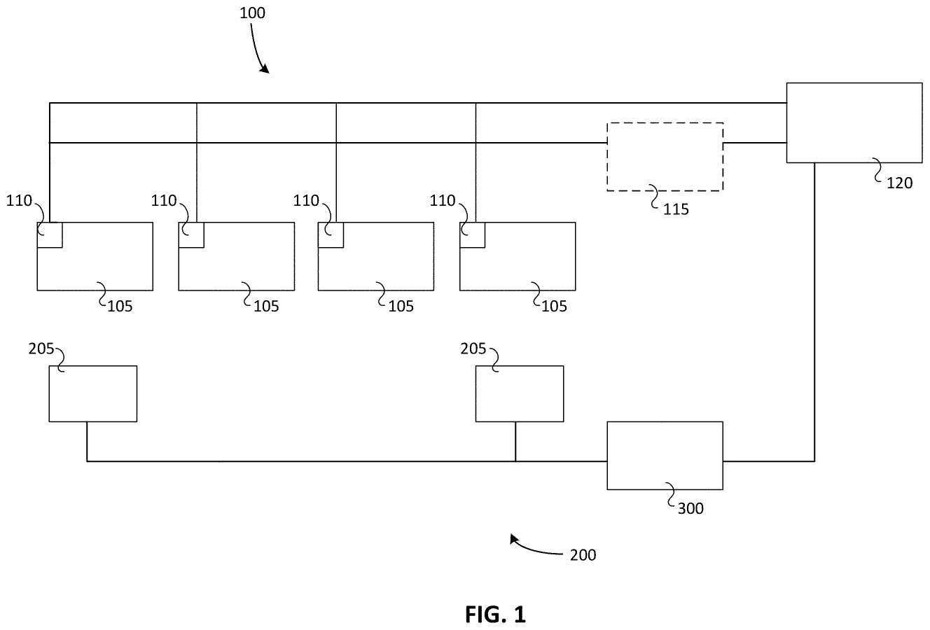

FIG. 1 shows an example environment 200 for a system for triggering training events 300 according to an embodiment herein. A production line 100 includes at least one automation station, or automation element, 105 (which in the current example includes four automation stations 105). As noted above, the automation stations 105 may be, for example, individual machines or equipment, or a combination of machines or equipment, or the like. Each automation station 105 may include an automation controller, such as a programmable logic controller (PLC) 110, which controls the automation station 105. Each PLC 110 is generally in communication with one or more servers or controllers, which may include a production controller 115 and may also or alternatively include a production monitoring server 120. The production controller 115 may provide direct control to and configuration of the PLCs 110 and monitor the overall production line 100. The production monitoring server 120 may monitor and process various operation data received from each PLC 110. Examples of operation data could include, but are not limited to, machine identification, timestamp, full machine state, environmental conditions, or any other data that could be provided in relation to a machine or automation station 105 in the production line.

The production controller 115 and the production monitoring server 120 may include a processor and memory (not shown in FIG. 1) allowing for the processing of various operations by each of these elements. It will be understood that the production controller 115 and the production monitoring server 120 may be combined or may be housed on a single physical computing device or may be distributed across a number of devices. (For the purposes of this document, the combination of the production controller 115 and the production monitoring server 120 may also be referred to as “production monitoring server 120”.)

The training system 300 according to an embodiment herein, may include one or more data acquisition or collection devices 205. The data collection devices 205 monitor the operation data received from the PLC 110 and identify trigger conditions or events that can be used to cause the system 300 to trigger a training event. In the description herein, the term “trigger event” will refer to an occurrence that may benefit from a review of the automation equipment or automation process and/or the use of any such equipment by an operator, or the like, and may include specific training related to the event or related to the equipment preforming the event.

Trigger events may be determined from the collected operation data may include machine stoppages, faulty part detection, out of specification operations or parts, a machine not responding or taking an action within or after a set time period, a new operator to the equipment, general repair or maintenance of a machine, a combination of events or data, incorrect process timing, and the like. Generally speaking, the trigger event initiates a training event associated with at least a part of the collected data, which is intended to be gathered or reviewed. In some cases, the collected data may also be reviewed and analyzed by the system in order to provide more directed training for further trigger events. In some cases, the system may benefit from machine learning with respect to trigger events and associated training. In some cases, the system may use artificial intelligence to determine trigger events from data analytics received or derived from the data collection devices 205.

In FIG. 1, two data collection devices 205 are shown. Data collection devices 205 may be any of various devices capable of collecting data that might be useful in diagnosing an issue and providing training with that issue, or associated with the machine being monitored. Examples of data collection devices 205 include cameras, pressure sensors, laser scanners, flow sensors, position sensors, accelerometers, 3D sensors, IR or heat cameras or sensors, acoustic sensors, proximity sensors, presence sensors and the like.

Each data collection device 205 may include a memory (not shown) for storing data captured by the data collection device 205. In some cases, the data collection device 205 may be in communication with a database or data store where additional data may be stored if the memory is not present or is not sufficiently large. Each data collection device 205 may continuously collect data and, if the memory becomes full, add new data to over-write the oldest data collected. In some cases, the data may overwrite data not associated with previous trigger events.

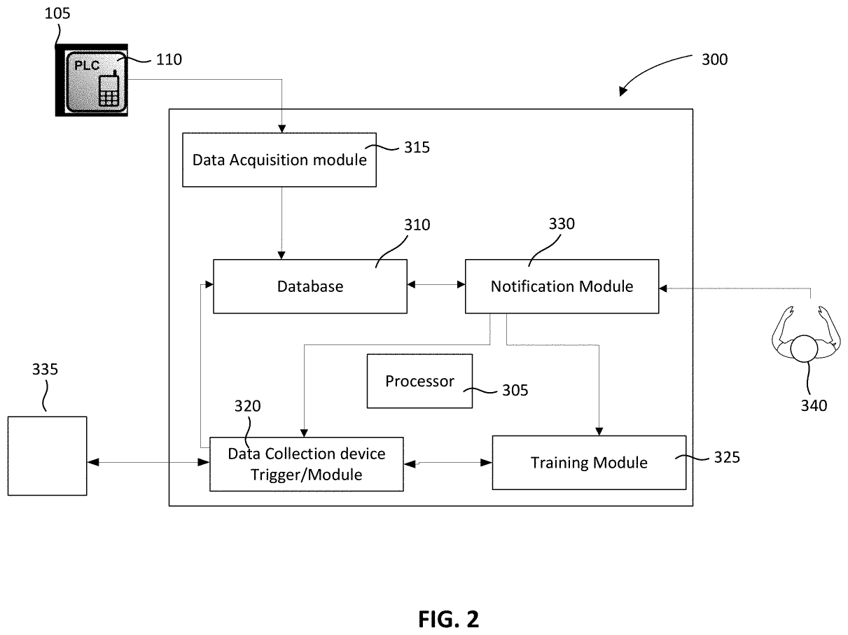

FIG. 2 is a block diagram illustrating an embodiment of a system for triggering training events 300 for automation systems. The system 300 includes a processor 305, a storage device (such as database 310 or a data store), a data acquisition module 315, a data collection device trigger, a training module 325, and a notification module 330. The system 300 may further be operatively connected to a data store 335, which may be physically connected to the system, may be wirelessly accessible by the system or may be accessible via a network connection. The system 300 may a standalone system or may be seen as part of the production monitoring server 120, the production controller 115 and/or the data collection device 205 and/or any combination thereof. The system 300 is intended to interact with an end user 340 and provide a training event for the end user 340. A training event is intended to provide the user with information, either a video, text, or the like, that provides the end user 340 with further detail regarding the trigger event and possible solutions to address the trigger event in order to either resume proper function or improve the functioning of the conveyor system.

The system 300 is intended to receive data associated with the automation system via the data acquisition module 315, which receives data from the one or more PLCs 110 related to the one or more automation stations 105, for example, via the data collection device 205.

As the PLC data flows into the system 300, the data acquisition module 315 is configured to review the operation, or PLC, data and monitors for data trigger events for training. As noted above a trigger event is generally data related to a new operator, new machinery, set up of an operation or process, maintenance, an error in the production process, or the like. For example, the data acquisition module 315 may review timing of an automation station to determine if there is a trigger event generated that would benefit from a training event.

In an example, it may be noted that an automation station or automation element is to be operated by a new employee. The new employee may benefit from a training module specifically addressing the specific automation station that is being used. In some cases, the training module may have been updated or otherwise annotated to provide the new employee with specific automation station notes to allow the new employee to better perform the operations associated with the automation station.

In some cases, the system 300 may further detect a confluence of events via, for example, machine learning, artificial intelligence or the like. In some further cases, the system may predict that a current set of circumstances has resulted in training being required, and, as such, may preemptively initiate relevant training.

The incoming operation data from, for example, the production monitoring servicer or the data acquisition module 315, may be saved into the database 310. The operation data may also be communicated to the data collection device trigger 320 and may further be stored in the data store 335. The data collection device trigger 320 may communicate with the training module 325 to determine whether the trigger event includes a training component associated with the trigger event that has been previously saved to the data store.

After determining whether there is a training session or training component that may be associated with the trigger event, the system 300 may determine the type of training available. Training component may include training manuals, training videos, instructional videos, augmented realty training, virtual reality training, 3^{rd} party training information, 3^{rd} party training platforms, or the like. The training component is intended to be related to and focus on the triggering event determined by the system 300. In some cases, the training components may be a video on how to address a particular fault in an automation station. In other cases, a to-do list may be provided to a new operator of an automation station that explains the particular steps and requirements for the operator of an automation station. In still other cases, a set or series of training events may be triggered to build knowledge related to a relevant topic. In still other cases, the training may be general training or behavior based training associated with an operator or user interaction with the automation equipment.

The notification module 330 can then notify an end user 340 of the availability of the training component and may provide the end user 340 access to the training component. In some cases, the end user 340 may be provided with a specific document or training video that includes the training, in other cases the end user may be provided a link or other manner to access the training remotely, or at a later time. The end user 340 may view the training in order to address the trigger event, for example, the end user may view training on how to fix a fault and then may address the fault in the automation station that triggered the event. In some cases, the end user may be an operator for the automation station. In other cases, the end user may be an internal or third party maintenance person who may have received a request to address the trigger event in addition to the receiving the training associated with the trigger event. It is intended that receiving notification of the event as well as the associated training may reduce the time it takes to address any issue that may slow or halt production.

The data acquisition module 315 may also provide access for the end user 340 to enter configurable settings for the system 300, for example by setting the types of events/trigger conditions for monitoring, the preferred types of training, who to contact based on the type of event, and the like. In some cases, the system may be operatively connected to a display in order to provide the end user 340 with a graphical user interface or other interface to allow the end user to update and configure settings. These updated settings are intended to be saved by the system and will be used by the system while monitoring for a trigger event. In some cases, the settings may be predetermined and may be updated and amended via machine learning or artificial intelligence included in the system.

Data collection devices 205 may, in some cases, be further associated with other input devices in order to monitor for triggering events. In some cases, the other input devices may receive input from end users 340 or operators of the conveyor system in order to receive further data associated with the conveyor system. It is intended that trigger events are determined in real time (or close to real time) in order for the training associated with the trigger event to be determined and accessed quickly to address any fault or issues in relation to the automation station.

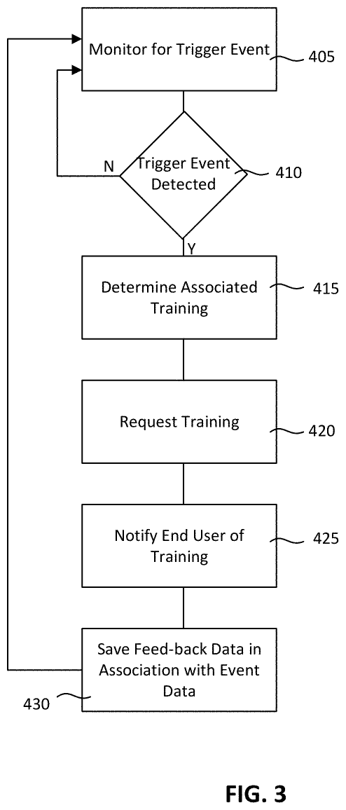

FIG. 3 is a flowchart of an embodiment of a method 400 for triggering training events. In this case, at 405, the system 300 monitors for a triggering event. The system 300 may receive data from the PLCs 110 which include for one or more trigger events related to the automation station 105 or the production line 100 or the like.

When a trigger event is detected 410, the training system 300 determines whether the trigger event requires the dissemination of training. If there is no training, then the system 300 continues to monitor for a further trigger event 405. If there is training, the training module 325 determines the associated training to the trigger event, at 415, by for example, comparing the trigger event to past trigger events to determine the most relevant training. The system then requests the training at 420, from, for example, the database, the data store or the like. In some cases, the training may also be stored locally. In other cases, the system may retrieve a link to the training and not the full training component.

At 425 the training is provided to the end user. In some cases, the end user may be associated with third party maintenance, and the system sends a notification to the third party regarding the trigger event and associated training. In other cases, an internal operator or maintenance worker may receive the training component or a link to the training component associated with the trigger event. The training and trigger event may be provided to the end user in order for the end user to easily determine which automation station and/or which machine or process within the automation station requires attention.

At 430, the system may further receive feed-back from the end-user or from further monitoring the automation station during the addressing of the triggering event. In some cases, the system 300 may request further feed-back from the end user. The feed-back is intended to allow the system to adapt the associated training to the trigger event. The associated training may then be more tailored to the trigger event and any other environmental factors that may affect the training. In some cases, the feed-back may include metadata related to the training event. The metadata that may be stored may include, for example, time to complete, score of any tests that were conducted, timing and navigation paths through the training, and the like.

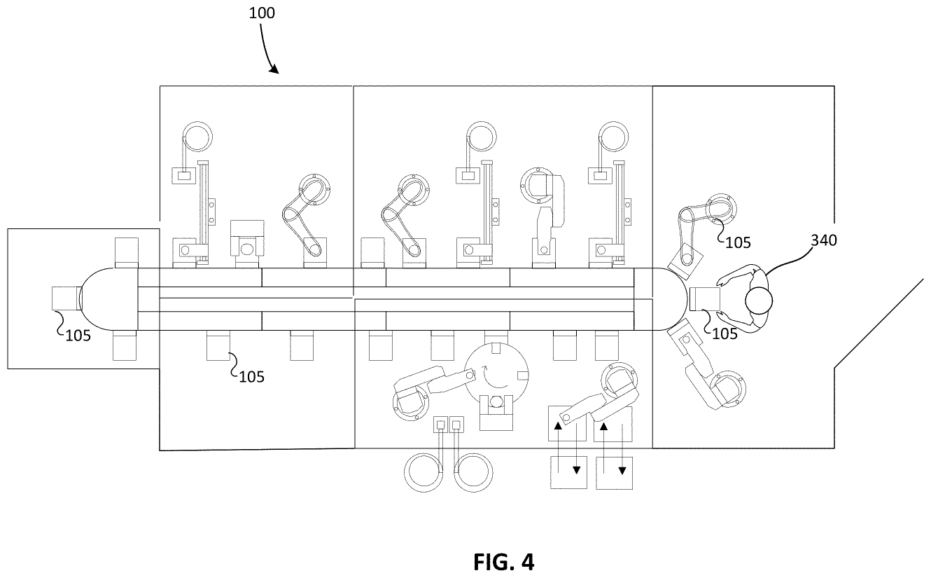

In some cases, the system may aid in sharing operator knowledge across shifts and sites housing automation equipment. In an example as illustrated in FIG. 4, a trigger event may be a machine fault and an operator or end user 340 may be directed to perform maintenance based on a training component located by the training module. The end-user may be directed to a specific automation station 105 which is associated with the trigger event. After performing maintenance, the operator may create additional training notes, for example a torque setting for a drive, that may be associated with the training component as part of the feed-back and may be retrieved or shared to other operators performing similar maintenance on the same equipment or similar equipment across various regions throughout the world. The feed-back provided by the operator may relate to set-up, operation, maintenance or other aspect of the training component or trigger event. In some cases, the information may be entered by the operator in a longer written format, in other cases, the operator may simply respond to a few questions or edit some material of the training component.

Returning to FIG. 3, the system 300 then returns to monitoring for trigger events 405.

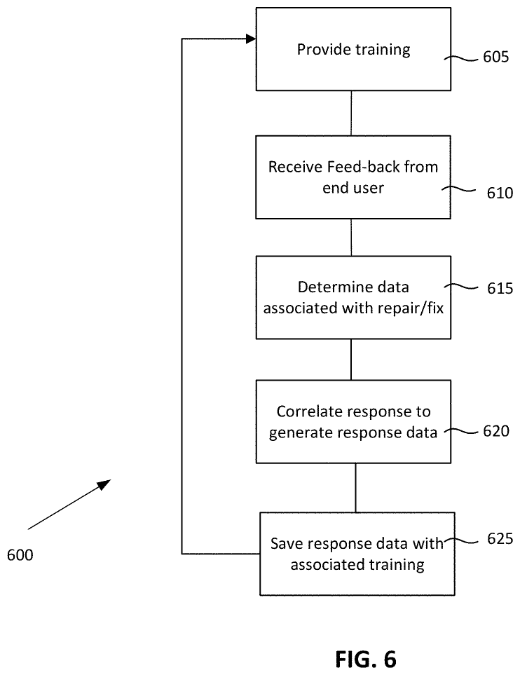

FIG. 6 illustrates a method 500 for determining associated training for the training event. The system 300 may receive or otherwise determine a trigger event at 505. At 510, the training module 325 may determine whether there is associated training that may be used to address the trigger event and that has been previously stored by the system, either in a local database or accessible via a data store. In some cases, the system the training module 325 may determine that there is associated training through review of previous training that may have been provided for a similar trigger event. In some cases, the associated training may be updated or amended based on feed-back received from end-users. At 515, the system accesses and retrieves the training. In some cases, the system may retrieve a link and/or access data related to the training and not the training component itself.

If there is not previously stored training, the system at 530 may review online and 3^{rd} party training. The data collection module 320 may be configured to search online and third party repositories for training that may address the trigger event. In some cases, the training module 325 may determine which training may be most relevant to the trigger event, at 535. In some cases, the system may employ machine learning to determine the most relevant training. In other cases, the system may include a weighting system to weight relevant factors, for example, key words, training format, third party ratings, length of training, and the like to evaluate the training and determine the most relevant training.

At 520, the notification module 330 notifies the end user 340 of the available training. At 525, the system may determine feed-back data associated with the trigger event and training. The feed-back may be used to determine relevancy and accuracy of the training. The feed-back may also be used to further tailor the training, for example with the inclusion of training notes, updated instructions, or the like.

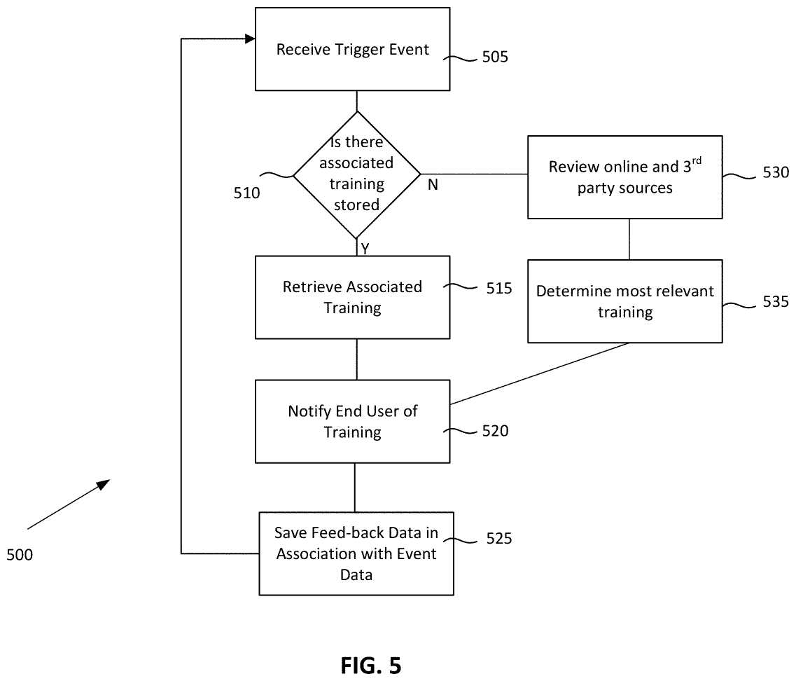

FIG. 5 illustrates a method 600 for determining relevancy of training. At 605, the system provides the training related to the trigger event to the end-user. The system may request and receive feed-back from the end user, at 610. In some cases, the data acquisition module 315 may provide an input form to the user to receive feed-back. In other cases, the end user may be provided with a survey or other manner to provide feed-back as to the effectiveness, accuracy, and ease-of-use of the training component.

At 615, the system may collect data associated with the training. In some cases, the system may determine efficiency data by determining, for example, the length of time the automation system experienced stoppage, the length of time the end user 340 took address the issue, the amount of the training component reviewed by the end-user, scores from tests during the training, frequency of the fault re-occurring, and the like.

At 620, the training module 325 may correlate the efficiency data and feed-back from the end-user to rank the training. In some cases, there may be a predetermined threshold and if the rank is below the predetermined reject threshold the training will not be re-used for the trigger event, and the training component may be deleted from the database or data store. In some cases, the efficiency data may be combined with the feed-back via a weighted summation which may weight certain criteria more heavily than others.

At 625, the response is associated with the training component. In some cases, if the response data is above a predetermined reject threshold then the training component may be starred or otherwise marked as highly beneficial in association with a particular trigger event. It is intended that after receiving various training components for various trigger events the system may be configured to provide more effective training, which is intended to allow for more efficient training solutions to the trigger events.

In some cases, the efficiency data may also consider the trigger event severity. In some cases, the severity may be preprogrammed in the system based on various triggering events. In other cases, the severity may be determined based on factors associated with the trigger event, for example, the time production was stopped, the cost of repair, the personnel able to address the event, and the like. Depending on the severity of the training, the system may rank a type of training component higher than another type. As an example, if the severity of the trigger event is seen as high, the training may determine that a virtual realty or augmented reality type would be beneficial. If the severity is considered low, the system may determine that a text based instruction manual may be sufficient.

In the preceding description, for purposes of explanation, numerous details are set forth in order to provide a thorough understanding of the embodiments of the invention. However, it will be apparent to one skilled in the art that these specific details are not required in order to practice the invention. In other instances, well-known electrical structures and circuits are shown in block diagram form in order not to obscure the invention. For example, specific details are not provided as to whether the embodiments of the invention described herein are implemented as a software routine, hardware circuit, firmware, or a combination thereof.

Embodiments of the invention can be represented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention can also be stored on the machine-readable medium. Software running from the machine-readable medium can interface with circuitry to perform the described tasks.

The above-described embodiments of the invention are intended to be examples only. Elements of each embodiment may be used with other embodiments and some elements may not be essential in each embodiment, as would be understood by one of skill in the art. Alterations, modifications and variations can be effected to the particular embodiments by those of skill in the art without departing from the scope of the invention, which is defined solely by the claims appended hereto.

What is claimed is:

1. A method for triggering a training event in a manufacturing line having at least one automation element, the method comprising:
receiving automation data associated with the at least one automation element;
detecting a trigger event based on the automation data;
determining a training component associated with the trigger event; and
providing access to the training component to an end user.

2. A method according to claim 1 further comprising: determining feed-back associated with the training component.

3. A method according to claim 2 wherein determining feed-back comprises:
receiving feed-back associated with the training component from the end user;
determining efficiency data associated with the training component; and
correlating the efficiency data and the feed-back to determine a feed-back score.

4. A method according to claim 3 wherein the efficiency data comprises at least one of: the a length of time the manufacturing line experienced stoppage, a length of time the end user took to address the trigger event, an amount of the training component reviewed by the end user, scores from tests initiated during the training component, and frequency of the trigger event.

5. A method according to claim 3, wherein determining the training component associated with the trigger event comprises:
reviewing the feed-back score associated with the training component; and
if the feed-back score is below a predetermined reject threshold,
disregarding the training component; and
retrieving a further training component associated with the trigger event;
otherwise, providing access to the training component to the end user.

6. A method according to claim 4, wherein determining the training component associated with the trigger event comprises:
reviewing the feed-back score associated with the training component; and
if the feed-back score is below a predetermined reject threshold,
disregarding the training component; and
retrieving a further training component associated with the trigger event;
otherwise, providing access to the training component to the end user.

7. A method according to claim 1 wherein the trigger event is detected via monitoring collected operation data of the manufacturing line.

8. A method according to claim 1 wherein the trigger event is an event associated with:
machine stoppages, faulty part detection, out of specification operations, a machine not responding within a set time period, a new operator, new equipment, general repair and maintenance, or a combination thereof.

9. A method according to claim 1 wherein at least one of the trigger event and the training component is determined via machine learning.

10. A system for triggering a training event in a manufacturing line having at least one automation element, the system comprising:
a data acquisition module configured to receive automation data associated with the at least one automation element;
a data collection device trigger configured to detect a trigger event based on the automation data;
a training module configured to determine a training component associated with the trigger event; and
a notification module configured to provide access to the training component to an end user.

11. A system according to claim 10 wherein the notification module is further configured to determine feed-back associated with the training component.

12. A system according to claim 11 wherein determining feed-back via the notification module comprises:
receiving feed-back associated with the training component from the end user;
determining efficiency data associated with the training component; and
correlating the efficiency data and the feed-back to determine a feed-back score.

13. A system according to claim 12 wherein the efficiency data comprises at least one of: a length of time the manufacturing line experienced stoppage, a length of time the end user took to address the trigger event, an amount of the training component reviewed by the end user, scores from tests initiated during the training component, and frequency of the trigger event.

14. A system according to claim 12 wherein the training module is further configured to:
review the feed-back score associated with the training component; and
if the feed-back score is below a predetermined reject threshold,
disregard the training component; and
retrieve a further training component associated with the trigger event;
otherwise, provide access to the training component to the end user.

15. A system according to claim 13 wherein the training module is further configured to:
review the feed-back score associated with the training component; and
if the feed-back score is below a predetermined reject threshold,
disregard the training component; and
retrieve a further training component associated with the trigger event;
otherwise, provide access to the training component to the end user.

16. A system according to claim 10 wherein the trigger event is detected via monitoring collected operation data of the manufacturing line.

17. A system according to claim 12 wherein the trigger event is detected via monitoring collected operation data of the manufacturing line.

18. A system according to claim 10 wherein the trigger event is an event associated with: machine stoppages, faulty part detection, out of specification operations, a machine not responding within a set time period, a new operator, new equipment, general repair and maintenance, or a combination thereof.
